(19) United States
(12) Patent Application Publication
(10) Pub. No.: US 2024/0294788 A1
(43) Pub. Date: Sep. 5, 2024

(54) Ink Jet Ink Composition And Ink Jet Recording Method

(71) Applicant: SEIKO EPSON CORPORATION, Tokyo (JP)

(72) Inventors: Tetsuya AOYAMA, Shiojiri (JP); Satoshi TSUBAMOTO, Osaka (JP); Masahiro YATAKE, Shiojiri (JP); Hiroaki KUMETA, Nagano (JP); Kenta KIKUCHI, Suwa (JP)

(21) Appl. No.: 18/591,221

(22) Filed: Feb. 29, 2024

(30) Foreign Application Priority Data
Mar. 1, 2023 (JP) 2023-030794

(51) Int. Cl. C09D 11/322

(52) U.S. Cl. CPC C09D 11/322

(57) ABSTRACT

An ink jet ink composition includes a pigment, a dispersant, and a biomass resin, the ink jet ink composition being an aqueous ink, in which the pigment is dispersed by the dispersant in water, and the dispersant includes a lignin compound.

The present application is based on, and claims priority from JP Application Serial Number 2023-030794, filed Mar. 1, 2023, the disclosure of which is hereby incorporated by reference herein in its entirety.

### BACKGROUND

### 1. Technical Field

The present disclosure relates to an ink jet ink composition and an ink jet recording method.

### 2. Related Art

Ink jet recording methods can record highly fine images with a relatively simple device and have been quickly developed in various fields. In such circumstances, various studies have been carried out to improve ink performance, while considering environmental issues. For example, JP-A-2022-167623 discloses an ink jet ink composition including a vegetable-derived carbonized coloring material and a lignin resin.

However, it has been recognized that there is a room for improvement in wear resistance and marker resistance in the ink jet ink composition described in JP-A-2022-167623.

### SUMMARY

The present disclosure is an ink jet ink composition including a pigment, a dispersant, and a biomass resin, the ink jet ink composition being an aqueous ink, in which the pigment is dispersed by the dispersant in water, and the dispersant includes a lignin compound.

### BRIEF DESCRIPTION OF THE DRAWINGS

FIG. 1 is a schematic diagram of a recording device used in an embodiment of the present disclosure.

FIG. 2 is a table showing results of examples.

### DESCRIPTION OF EMBODIMENTS

Hereinafter, an embodiment of the present disclosure (hereinafter, referred to as the “present embodiment”) will be described in detail. However, the present disclosure is not limited thereto, and can be modified in various ways without departing from the spirit thereof.

### 1. Ink Jet Ink Composition

An ink jet ink composition (hereinafter, also referred to simply as the “ink composition”) according to the present embodiment includes a pigment, a dispersant, and a biomass resin, the ink jet ink composition being an aqueous ink, in which the pigment is dispersed by the dispersant in water, and the dispersant includes a lignin compound.

In order to provide an environment-friendly ink composition, the lignin compound is used as the dispersant for the pigment. Lignin compounds are materials derived from organic resources generated from animals and plants except for fossil resources (hereinafter, also referred to as “derived from animals and plants”), are promising materials for reducing CO₂ emission amounts, and have excellent performance as a dispersant for pigments. However, a recorded material printed using an ink composition in which a pigment is dispersed by a lignin compound leaves a room for improvement in wear resistance and marker resistance.

In the present embodiment, since the ink composition in which the pigment is dispersed by the lignin compound further includes the biomass resin, the ink composition tends to have excellent wear resistance and excellent marker resistance, while reducing CO₂ emission amounts. It is considered that excellent wear resistance and excellent marker resistance are provided while reducing CO₂ emission amounts, because a material derived from an animal or a plant is used for the biomass resin, the biomass resin has high affinity with the lignin compound which is also derived from an animal or a plant, and the biomass resin has a function as a fixing resin capable of fixing the pigment to which the lignin compound is attached as the dispersant. However, factors providing excellent wear resistance and excellent marker resistance while reducing CO₂ emission amounts are not limited thereto.

As described above, the biomass resin has high affinity with lignin compounds. Therefore, high dispersion stability of the pigment dispersed by the lignin compound is maintained even when the ink composition further includes the biomass resin, which is preferable.

A biomass degree of the solid content of the ink composition is preferably 50% to 100%, 60% to 100%, 70% to 100%, or 80% to 100%. When the biomass degree of the solid content of the ink composition falls within the above ranges, the ink composition achieves reduction in CO₂ emission amounts. The biomass degree herein is a dry weight ratio of a biomass raw material used.

Biomass raw materials refer to organic resources generated from animals and plants except for fossil resources. In the present embodiment, the biomass resin, the lignin compound, the pigment derived from an animal or a plant correspond to the biomass raw materials, for example.

The biomass degree can be measured by a known method based on the ¹⁴C concentration measured by accelerator mass spectrometry (AMS). More specifically, the biomass degree can be measured by the method described in the examples.

A volume average particle diameter D50 of the ink composition is preferably 300 nm or less, 50 to 300 nm, 100 to 275 nm, or 100 to 250 nm. When the D50 of the ink composition falls within the above ranges, wear resistance and marker resistance tend to be excellent.

The D50 of the ink composition can be measured by a known particle size distribution measurement device. More specifically, the D50 can be measured by the method described in the examples such as a dynamic light scattering method. In addition, the D50 of the ink composition can be adjusted by changing components of the ink composition, changing the composition of the ink composition, or changing dispersion conditions of the ink composition, for example.

Hereinafter, each component of the ink composition of the present embodiment will be described in detail.

### 1.1. Pigment

The ink composition of the present embodiment includes a pigment. Although the pigment is not particularly limited, examples thereof include natural mineral pigments such as a bole, ocher, terre verte, marachite, chalk, and graphite; synthetic inorganic pigments such as iron blue, zinc oxide, cobalt blue, emerald green, viridian, titanium white, and iron oxide; organic pigments such as alkali blue, lithol red, disazo yellow, and petroleum-derived carbon black; vegetable charcoal such as bamboo charcoal and wood charcoal like Bincho charcoal; carbon black (vegetable oil charcoal) derived from vegetable oil obtained by using, as a raw material, castor oil, rosin oil, or the like; and animal-derived pigments obtained by using, as a raw material, squid ink, octopus ink, or the like. Among them, from the viewpoint of reducing CO₂ emission amounts, natural mineral pigments, synthetic inorganic pigments, vegetable charcoal, vegetable oil charcoal, and animal-derived pigments are preferable, and vegetable charcoal and vegetable oil charcoal are more preferable. One kind of the pigment may be used alone, or two or more kinds thereof may be used in combination.

The content of the pigment is preferably 1% to 20% by mass, 2% to 15% by mass, or 4% to 10% by mass based on the total amount of the ink composition. When the content of the pigment falls within the above ranges, wear resistance and marker resistance tend to be excellent.

### 1.2. Dispersant

The dispersant included in the ink composition of the present embodiment includes the lignin compound. When the dispersant includes the lignin compound, the pigment can be well dispersed in the ink composition. In particular, when vegetable charcoal or vegetable oil charcoal is used as the pigment, since vegetable charcoal and vegetable oil charcoal include a lignin component, the pigment has high affinity with the lignin compound, and higher dispersibility is exhibited.

Although the lignin compound is not particularly limited, examples thereof include lignin and a lignin derivative. Although the lignin derivative is not particularly limited, examples thereof include lignosulfonates, lignin sulfonates (sodium lignosulfonate, potassium lignosulfonate, and the like), kraft lignin, and soda lignin. All of them are obtained from black liquor produced during pulp production, and lignosulfonates are obtained with a sulfurous acid method, kraft lignin is obtained with a kraft method, and soda lignin is obtained with a soda method. However, methods for obtaining these kinds of lignin are not limited thereto.

A dispersant other than the lignin compound may be included. Although such a dispersant is not particularly limited, examples thereof include vinyl-based polymers and copolymers, acrylic polymers and copolymers, polyesters, polyamides, polyimides, polyurethanes, amino-based polymers, silicon-containing polymers, sulfur-containing polymers, fluorine-containing polymers, and epoxy resins. One kind of the dispersant may be used alone, or two or more kinds thereof may be used in combination.

The content of the dispersant is preferably 1% to 15% by mass or 3% to 10% by mass based on the total amount of the ink composition. When the content of the dispersant falls within the above ranges, discharge stability and sedimentation performance tend to be excellent.

The content of the lignin compound is preferably 1% to 15% by mass or 3% to 10% by mass based on the total amount of the ink composition. When the content of the lignin compound falls within the above ranges, discharge stability and sedimentation performance tend to be excellent.

A mass ratio (C/A) of the content C of the lignin compound to the content A of the pigment is preferably 0.1 to 6.0, 0.2 to 5.0, 0.3 to 4.0, 0.4 to 2.5, 0.5 to 2.0, or 0.6 to 1.5. When the mass ratio (C/A) falls within the above ranges, discharge stability and sedimentation performance tend to be excellent.

### 1.3. Biomass Resin

As described above, a recorded material printed using an ink composition in which a pigment is dispersed by a lignin compound leaves a room for improvement in wear resistance and marker resistance. However, when the ink composition in which the pigment is dispersed by the lignin compound further includes the biomass resin, wear resistance and marker resistance tend to be excellent, while reducing CO₂ emission amounts.

When the biomass resin has one or more kinds of an alicyclic structure or an aromatic ring structure, wear resistance and marker resistance tend to be excellent. Factors providing tendency of wear resistance and marker resistance to be made excellent are considered as follows: because the lignin compound included in the ink composition has a cyclic structure, when the biomass resin has one or more kinds of an alicyclic structure and an aromatic ring structure, affinity between the biomass resin and the lignin compound is improved to improve a function of the biomass resin as a fixing resin. However, factors providing tendency of wear resistance and marker resistance to be made excellent are not limited thereto.

The biomass resin is not particularly limited but is, for example, a resin produced from a monomer produced only from a biomass raw material or from a monomer produced from a raw material including a biomass raw material (hereinafter, the two kinds of monomers are also collectively referred to as the “biomass monomer”). The biomass resin may be a resin produced only from the biomass monomer or may be a resin produced from the biomass monomer and a petroleum-derived monomer.

Although the biomass monomer is not particularly limited, examples thereof include (meth)acrylic acid, (meth)acrylates (methyl (meth)acrylate, butyl (meth)acrylate, stearyl (meth)acrylate, isobornyl (meth)acrylate, etc.), acrylonitrile, cyanoacrylate, ethylene glycol dimethacrylate, acrylamide, diphenylmethane diisocyanate, tolylene diisocyanate, polypropylene glycol, polyester polyol, polycaprolactone polyol, polycarbonate diol, polybutadiene polyol, ethylene glycol, 1,3-propanediol, 1,4-butanediol, 1,4-cyclohexanedimethanol, terephthalic acid, 2,6-naphthalendicarboxylic acid, olefin, styrene, vinyl acetate, vinyl chloride, vinyl alcohol, vinyl ether, vinyl pyrrolidone, vinyl pyridine, vinyl carbazole, vinyl imidazole, and vinylidene chloride. One kind of the biomass monomer may be used alone, or two or more kinds thereof may be used in combination.

Although the biomass resin is not particularly limited, examples thereof include a biourethane resin, a biopolyester resin, and a bioacrylic resin which are produced using one or more kinds selected from the group consisting of the above-described biomonomers, and a bioacrylic resin is preferable. A form of the biomass resin is not particularly limited but may be a water-soluble resin, resin fine particles, or resin emulsion, for example.

Among the above-described monomers, the biomass monomer is preferably a (meth)acrylate such as stearyl (meth)acrylate and isobornyl (meth)acrylate and more preferably a (meth)acrylate having one or more kinds of an alicyclic structure and an aromatic ring structure such as isobornyl (meth)acrylate. When a resin produced from any of these biomass monomers is used, wear resistance and marker resistance tend to be excellent, while reducing CO₂ emission amounts. In addition, affinity with the lignin compound is improved by having, for example, an isobornyl group with a cyclic structure compared with a linear structure, making fixability of a base material of a coloring material coating film stronger, and wear resistance and marker resistance tend to be more excellent.

The content of the biomass resin is preferably 0.1% to 20.0% by mass, 0.5% to 15.0% by mass, 1.0% to 10.0% by mass, or 2.5% to 7.5% by mass based on the total amount of the ink composition. When the content of the biomass resin falls within the above ranges, wear resistance and marker resistance tend to be excellent.

A mass ratio (B/A) of the content B of the biomass resin to the content A of the pigment is preferably 0.1 to 8.0, 0.2 to 7.0, 0.5 to 6.0, 0.6 to 4.0, or 0.7 to 3.0. When the mass ratio (B/A) falls within the above ranges, wear resistance and marker resistance tend to be excellent.

### 1.4. Organic Solvent

The ink composition of the present embodiment may include an organic solvent. Although the organic solvent is not particularly limited, examples thereof include aqueous organic solvents such as monovalent alcohols, polyols, and glycol ethers. Among them, polyols are preferably included. When the organic solvent is included, wear resistance and marker resistance tend to be excellent. One kind of the organic solvent may be used alone, or two or more kinds thereof may be used in combination.

The monovalent alcohols are not particularly limited, examples thereof include methanol, ethanol, 1-propanol, isopropanol, 1-butanol, 2-butanol, isobutanol, and 2-methyl-2-propanol.

The polyols are not particularly limited, examples thereof include diols such as ethylene glycol, diethylene glycol, triethylene glycol, tetraethylene glycol, pentaethylene glycol, propylene glycol, dipropylene glycol, tripropylene glycol, tetrapropylene glycol, 1,3-propanediol, 1,2-butanediol, 1,3-butanediol, 1,2-pentanediol, 1,2-hexanediol, 1,4-butanediol, 1,5-pentanediol, and 1,6-hexanediol; triols such as 1,2,5-hexanetriol, 1,2,6-hexanetriol, polyoxypropylenetriol, and glycerin; and tetraols such as pentaerythritol.

The glycol ethers are not particularly limited, examples thereof include triethylene glycol monomethyl ether, triethylene glycol dimethyl ether, triethylene glycol monobutyl ether, diethylene glycol monobutyl ether, and dipropylene glycol monopropyl ether.

The content of the organic solvent is preferably 2% to 35% by mass, 3% to 30% by mass, 5% to 25% by mass, or 10% to 20% by mass based on the total amount of the ink composition. When the content of the organic solvent falls within the above ranges, wear resistance and marker resistance tend to be excellent.

### 1.5. Surfactant

The ink composition of the present embodiment may include a surfactant. Although the surfactant is not particularly limited, examples thereof include an acetylene glycol-based surfactant, a fluorine-based surfactant, and a polysiloxane-based surfactant. One kind of the surfactant may be used alone, or two or more kinds thereof may be used in combination.

The acetylene glycol-based surfactant is not particularly limited but is preferably one or more kinds selected from alkylene oxide adducts of 2,4,7,9-tetramethyl-5-decyne-4,7-diol and 2,4,7,9-tetramethyl-5-decyne-4,7-diol and alkylene oxide adducts of 2,4-dimethyl-5-decyne-4-ol and 2,4-dimethyl-5-decyne-4-ol, for example. Although commercially available products of the acetylene glycol-based surfactant are not particularly limited, examples thereof include OLFINE 104 series and E series such as OLFINE E1010 (manufactured by Nissin Chemical Industry Co., Ltd.), and SURFYNOL 104 and SURFYNOL 61 (manufactured by Evonik Industries AG).

Although the fluorine-based surfactant is not particularly limited, examples thereof include a perfluoroalkylsulfonate, a perfluoroalkylcarboxylate, perfluoroalkylphosphate, a perfluoroalkyl ethylene oxide adduct, a perfluoroalkyl betaine, and a perfluoroalkyl amine oxide compound. Although commercially available products of the fluorine-based surfactant are not particularly limited, examples thereof include S-144 and S-145 (manufactured by AGC Inc.); FC-170C, FC-430, and Fluorad-FC4430 (manufactured by Sumitomo 3M Limited); FSO, FSO-100, FSN, FSN-100, FS-300 (manufactured by DuPont de Nemours, Inc.); and FT-250 and 251 (manufactured by NEOS COMPANY LIMITED).

The silicone-based surfactant includes a polysiloxane-based compound, a polyether-modified organosiloxane, and the like. Although commercially available products of the silicone-based surfactant are not particularly limited, specific examples thereof include BYK-306, BYK-307, BYK-333, BYK-341, BYK-345, BYK-346, BYK-347, BYK-348, and BYK-349 (manufactured by BYK Japan KK); and KF-351A, KF-352A, KF-353, KF-354L, KF-355A, KF-615A, KF-945, KF-640, KF-642, KF-643, KF-6020, X-22-4515, KF-6011, KF-6012, KF-6015, and KF-6017 (manufactured by Shin-Etsu Chemical Co., Ltd.).

The content of the surfactant is preferably 0.1% to 5.0% by mass or 0.2% to 2.0% by mass based on the total amount of the ink composition.

### 1.6. Water

Although water included in the ink composition of the present embodiment is not particularly limited, examples thereof include ion-exchanged water, ultrafiltrate water, reverse osmosis water, and distilled water. An “aqueous ink” in the present embodiment refers to an ink composition including water as a main solvent component.

The content of water is preferably 60% to 90% by mass or 65% to 80% by mass based on the total amount of the ink composition.

### 1.7 Other Components

The ink composition of the present embodiment may include other known components used in ink compositions before in addition to the above-described components. Although the other components are not particularly limited, examples thereof include other additives such as a dissolving aid, a viscosity adjuster, a pH adjuster, an antioxidant, an antiseptic agent, a corrosion inhibitor, and a chelating agent for trapping predetermined metal ions affecting dispersion; and an organic solvent other than those described above. One kind of the other components may be used alone, or two or more kinds thereof may be used in combination.

### 2. Ink Composition Production Method

Although an ink composition production method of the present embodiment is not particularly limited, each of the components described above may be mixed, for example. In the ink composition production method of the present embodiment, a pigment dispersion liquid in which the pigment and the dispersant are dispersed in water may be prepared, and the obtained pigment dispersion liquid and each of the other components described above may be mixed.

The pigment dispersion liquid may be preliminarily prepared before preparing the ink composition, or may be prepared through mixing and dispersion carried out simultaneously with other components when the ink composition is prepared.

Although the pigment dispersion liquid is not particularly limited, the pigment dispersion liquid may be obtained by mixing the pigment, the dispersant, and water using a pin type horizontal bead mill, for example. Beads used at this time may be zirconia beads with a diameter of 0.3 mm, for example, and the diameter and material are appropriately selected based on desired physical properties. The dispersion processing time with a sand grinder is preferably 0.5 to 3.0 hours or 0.5 to 2.5 hours.

### 3. Recording Medium

Although a recording medium used for recording with the ink composition of the present embodiment is not particularly limited, examples thereof include an absorptive recording medium, a low-absorptive recording medium, and a non-absorptive recording medium.

Although the absorptive recording medium is not particularly limited, examples thereof include regular paper such as electrophotographic paper, ink jet paper (exclusive paper for ink jet printing including an ink absorptive layer composed of silica particles or alumina particles or including an ink absorptive layer composed of a hydrophilic polymer such as polyvinyl alcohol (PVA) or polyvinyl pyrrolidone (PVP)), and fabric, which have high ink permeability.

Although the low-absorptive recording medium is not particularly limited, examples thereof include art paper, coated paper, and cast paper, which have relatively low ink permeability and are used for general offset printing.

Although the non-absorptive recording medium is not particularly limited, examples thereof include a film and plate of plastic such as polyvinyl chloride, polyethylene, polypropylene, polyethylene terephthalate (PET), polycarbonate, polystyrene, and polyurethane; a plate of metal such as iron, silver, copper, and aluminum; a metal plate produced through deposition of such various kinds of metal, a plastic film, a plate of alloy such as stainless steel and brass; and a recording medium in which a film of plastic such as polyvinyl chloride, polyethylene, polypropylene, polyethylene terephthalate (PET), polycarbonate, polystyrene, and polyurethane is adhered (coated) onto a paper base material.

Although regular paper is generally used for business ink jet printers among recording media, since regular paper has no ink receiving layer unlike ink jet paper, wear resistance tends to be poor in the case of printing on regular paper. However, when using the ink composition of the present embodiment, sufficient wear resistance and marker resistance tend to be provided even in the case of printing on regular paper using a business ink jet printer.

### 4. Ink Jet Recording Method

An ink jet recording method of the present embodiment includes an ink adhering step of discharging, from an ink jet head, the ink composition of the present embodiment and adhering same to a recording medium. In addition, the ink jet recording method of the present embodiment may include other steps such as a transporting step of transporting the recording medium, if needed.

### 4.1. Ink Adhering Step

In the ink adhering step, the ink composition of the present embodiment is discharged from an ink jet head and adhered to a recording medium. More specifically, a pressure generation means provided inside an ink jet head is driven to discharge, from a nozzle, the ink composition filling a pressure generation chamber of the ink jet head.

The ink jet head used in the ink adhering step includes a line head for recording in a line method and a serial head for recording in a serial method.

In the line method using a line head, an ink jet head having a width equal to or more than the recording width of the recording medium is fixed to a recording device, for example. Then, the recording medium is moved along the vertical scanning direction (recording medium transporting direction), and ink droplets are discharged from a nozzle of the ink jet head in conjunction with this movement to record an image on the recording medium.

In the serial method using a serial head, an ink jet head is mounted to a carriage capable of moving in the width direction of the recording medium, for example. Then, the carriage is moved along the main scanning direction (width direction of the recording medium), and ink droplets are discharged from a nozzle of the ink jet head in conjunction with this movement to record an image on the recording medium.

### 4.2. Transporting Step

The ink jet recording method of the present embodiment may include a transporting step. In the transporting step, the recording medium is transported in a predetermined direction within the recording device. More specifically, the recording medium is transported from a paper feeder to a paper discharger of the recording device using a transporting roller and a transporting belt provided within the recording device. The ink composition discharged from the ink jet head is adhered to the recording medium during this transporting process to form a recorded material. The ink adhering step and the transporting step may be simultaneously conducted or may be alternatively conducted.

### 5. Recording Device

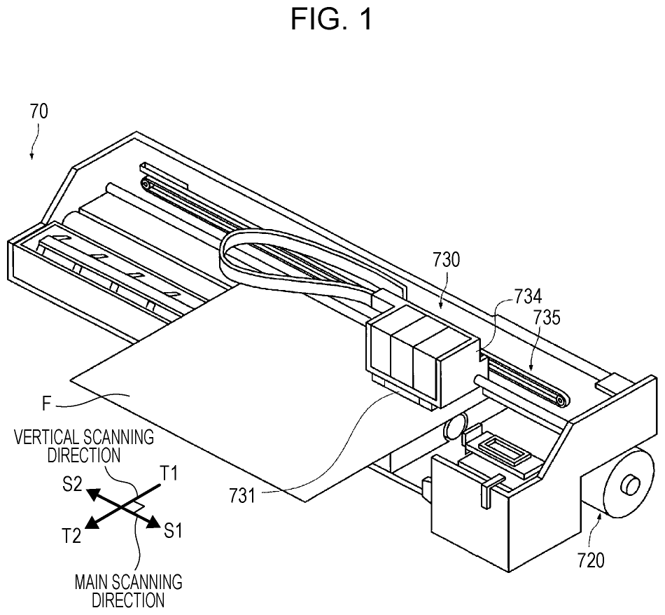

As an example of the ink jet device, a perspective view of a serial printer is illustrated in FIG. 1. As illustrated in FIG. 1, the serial printer 20 includes a transporter 220 and a recorder 230. The transporter 220 transports a recording medium F fed to the serial printer to the recorder 230, and the recording medium after recording is discharged to the outside of the serial printer. Specifically, the transporter 220 has feeding rollers and transports the fed recording medium F in the vertical scanning direction T2.

The recorder 230 includes: a carriage 234 to which an ink jet head 231 having a nozzle discharging the ink composition to the recording medium F fed from the transporter 220 is mounted; and a carriage moving mechanism 235 moving the carriage 234 in the main scanning direction S1, S2 of the recording medium F.

In the case of the serial printer, a head having a length smaller than the width of the recording medium is provided as the ink jet head 231, the head moves, and recording is carried out with multiple paths. In addition, the head 231 is mounted to the carriage 234 moving in a predetermined direction in the serial printer, and the ink composition is discharged onto the recording medium F as the head moves with movement of the carriage. Recording is thus carried out with two or more paths. Incidentally, the path is also referred to as main scanning. Vertical scanning transporting the recording medium is carried out between paths. That is, main scanning and vertical scanning are alternatively carried out.

In addition, the ink jet device of the present embodiment is not limited to this serial-type printer and may be a line-type printer described above. The line-type printer is a printer carrying out recording on a recording medium through scanning once, using a line head which is an ink jet head having a length equal to or larger than the recording width of the recording medium.

Since business ink jet printers (BIJ printers) mainly used for printing on regular paper require a larger amount of ink used, use of the ink composition of the present embodiment for a BIJ printer can reduce CO₂ emission amounts compared with the case where a heretofore used ink jet ink composition using a petroleum source-derived material is used, and is preferable.

### EXAMPLES

Hereinafter, the present disclosure will be more specifically described using examples and comparative examples. The present disclosure is not limited to the following examples.

### 1. Preparation of Pigment Dispersion Liquid

Ten parts by mass of a pigment and 10 parts by mass of a dispersant were well mixed with 50 parts by mass of ion-exchanged water, followed by dispersion processing with zirconia beads having a diameter of 0.3 mm using a pin type horizontal bead mill for two hours to obtain a pigment dispersion liquid.

### 2. Preparation of Ink Jet Ink Composition

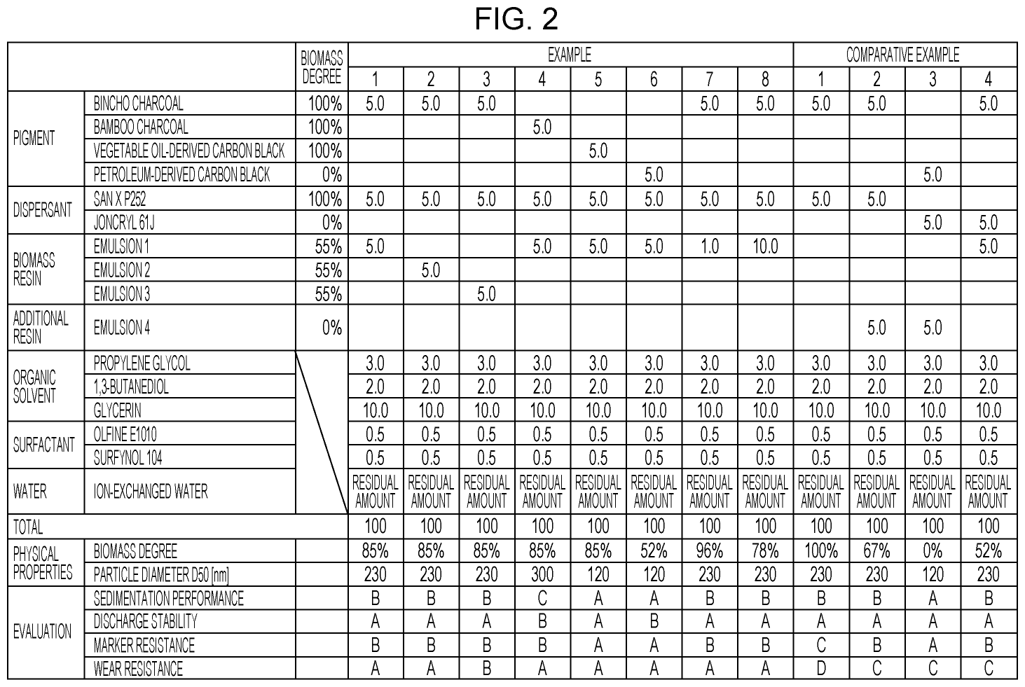

The obtained pigment dispersion liquid and the rest of components were put into a mixture tank and mixed so as to achieve each of the compositions shown in FIG. 2, thereby obtaining an ink composition of each of the examples and the comparative examples. Incidentally, the numerical values for the respective components shown in FIG. 2 for each example are represented by mass % unless otherwise stated. In addition, the contents (mass %) of the pigments, the dispersants, and biomass resins in FIG. 2 are solid concentrations.

The materials shown in FIG. 2 are as follows.
Pigment
Bincho charcoal (manufactured by Kiriya Chemical Co., LTD., Bincho charcoal powder)
Bamboo charcoal (manufactured by Kiriya Chemical Co., LTD., bamboo charcoal powder)
Vegetable oil-derived carbon black (carbon black obtained by the production method described in example 1 of JP-A-2009-024071)
Petroleum-derived carbon black (C.I. Pigment Black 7, manufactured by Mitsubishi Chemical Corporation)
Dispersant
San X P252 (Sodium lignosulfonate, manufactured by Nippon Paper Industries Co., Ltd.)
Joncryl 61J (manufactured by BASF SE)
Organic solvent
Propylene glycol
1,3-butanediol
Glycerine
Surfactant
OLFINE E1010 (manufactured by Nissin Chemical Industry Co., Ltd.)
SURFYNOL 104 (manufactured by Evonik Industries AG)
Water
Ion-exchanged water
Biomass resin

Emulsion 1: Into a reaction container equipped with a stirrer, a reflux condenser, a dropping device, and a thermometer were put 900 g of ion-exchanged water and 3 g of sodium sulfate, followed by nitrogen substitution, and the temperature was increased to 70° C. while stirring. The internal temperature was kept at 70° C., 4 g of potassium persulfate was added as a polymerization initiator, and after dissolution, an emulsion preliminarily prepared by adding, to 450 g of ion-exchanged water, 3 g of sodium lauryl sulfate, 20 g of acrylamide, 1250 g (6 mol) of isobornyl acrylate (IBXA), which was a biomass monomer, 380 g of butyl acrylate, 30 g of methacrylic acid, and 2 g of ethylene glycol dimethacrylate while stirring was continuously dropped into the reaction container over four hours. After completion of drop, aging was conducted for three hours. After the obtained aqueous emulsion was cooled to ordinary temperature (25° C.), ion-exchanged water and ammonia water were added to adjust the solid content mass to 40% by weight and adjust the pH value to 8.

Emulsion 2: Emulsion 2 was prepared in the same preparation method as Emulsion 1 except that isobornyl methacrylate (IBMA), which was a biomass monomer, was used in the equimolar amount instead of IBXA in the preparation of Emulsion 1 described above.

Emulsion 3: Emulsion 3 was prepared in the same preparation method as Emulsion 1 except that stearyl acrylate (STA), which was a biomass monomer, was used in the equimolar amount instead of IBXA in the preparation of Emulsion 1 described above.

### Additional Resin

Emulsion 4: Emulsion 4 was prepared in the same preparation method as Emulsion 1 except that methyl acrylate (MA), which was not a biomass monomer, was used in the equimolar amount instead of IBXA in the preparation of Emulsion 1 described above.

IBXA, IBMA, STA, and MA used for preparing Emulsion 1 to Emulsion 4 above are as follows.
IBXA (manufactured by OSAKA ORGANIC CHEMICAL INDUSTRY LTD., biomass acrylate)
IBMA (b-IBOMA, manufactured by SANWACHEMIPHAR CORPORATION, biomass acrylate)
STA (manufactured by OSAKA ORGANIC CHEMICAL INDUSTRY LTD., biomass acrylate)
MA (manufactured by Tokyo Chemical Industry Co., Ltd.)

The biomass degree of each component for each ink composition was calculated based on the concentration of ¹⁴C, which was an isotope of ¹²C, and the concentration of ¹⁴C was measured by accelerator mass spectrometry (AMS). In addition, the biomass degree of the solid content of each ink composition was calculated based on the biomass degrees of the respective solid components for each ink composition. Specifically, the biomass degree was calculated according to the following formula.

(Sum of biomass degree×mass % values of respective components)/(sum of mass % of respective components)
The respective components here are the pigment, the dispersant, the biomass resin, and the additional resin.

The volume average particle diameter D50 of the ink composition was measured by a dynamic light scattering method. ELSZ-1000 (manufactured by Otsuka Electronics Co., Ltd.) was used as a measurement device.

### 3. Evaluation

### 3.1. Sedimentation Performance

Each ink composition was put into a centrifuging tube such that the total mass of the centrifuging tube, a lid, and the ink composition became 55 g, and the centrifuging tube was capped with the lid. The centrifuging tube with the lid was set in a centrifugal machine (CR-20B2, ROTOR No. 36, manufactured by Hitachi Koki Co., Ltd.) and subjected to centrifugation at a rotational frequency of 10000 rpm for 15 minutes, and 5 mL of the solution was collected from the vapor-liquid interface. The absorbance of light at a wavelength of 500 nm of each of the supernatant liquid obtained as described above and the ink composition before centrifugation was measured. Then, the sedimentation rate (P1) was calculated according to the following formula using the absorbance (C0) of light at a wavelength of 500 nm of the ink composition before centrifugation and the absorbance (C1) of light at a wavelength of 500 nm of the supernatant liquid and evaluated according to the following evaluation criteria.

$$P 1 ( \% ) = ( C 1 / C 0 ) \times 100$$

### Evaluation Criteria

A: P1 is 90% or more.
B: P1 is 80% or more and less than 90%.
C: P1 is less than 80%.

### 3.2. Discharge Stability

Using an ink jet recording device (“PX-S840” manufactured by Seiko Epson Corporation), an ink cartridge of the ink jet recording device was filled with each ink composition, and it was confirmed that all nozzles can discharge the ink composition. Thereafter, printing was continuously carried out on 50 sheets of A4 regular paper in 100% duty solid printing. After printing, discharge stability was evaluated from the number of nozzles (number of missing nozzles) that could not discharge the ink composition according to the following evaluation criteria.

### Evaluation Criteria

A: The number of missing nozzles is less than 10.
B: The number of missing nozzles is 10 or more and less than 20.
C: The number of missing nozzles is 20 or more and less than 50.
D: The number of missing nozzles is 50 or more.

### 3.3. Maker Resistance

A recorded material was obtained in the same manner as in the discharge stability test described above, and natural drying was conducted for 30 minutes after printing. The boundary between the surface of the recording medium on which the ink composition is printed and the surface without printing was traced with a commercially available aqueous highlighter pen (text liner manufactured by FABER-CASTELL), and the staining degree at that time was visually observed and evaluated with three panelists according to the following criteria. Scores A, B, and C are all evaluation results at a level not practically problematic, but score D is an evaluation result at a level practically problematic.

### Evaluation Criteria

A: No staining such as tailing is caused even tracing with the highlighter pen twice.
B: No staining such as tailing is caused even tracing with the highlighter pen once, but staining such as tailing is caused when tracing with the highlighter pen twice.
C: Staining such as tailing is caused when tracing with the highlighter pen once.
D: Remarkable staining such as tailing is caused when tracing with the highlighter pen once.

### 3.4. Wear Resistance

Evaluation was conducted using Gakushin-type abrasion resistance evaluation device AB-301 from TESTER SANGYO CO. LTD. in accordance with JIS L0849 2013. The abrasion resistance test includes a dry friction test tested with dry cannequin and a wet friction test tested with wet cannequin, and both tests were conducted. The dry friction test was conducted under the condition of 100 reciprocation cycles with a load of 200 g, and the wet friction test was conducted under the condition of 10 reciprocation cycles with a load of 200 g.

A recorded material having a size of 1.0 inches×0.5 inches was obtained using an ink jet recording device (“PX-S840” manufactured by Seiko Epson Corporation) in the same manner as the discharge stability test. Cannequin was pressed against the solid image on the recorded material a day after recording, and evaluation was conducted. Thereafter, staining on the cannequin, staining in a non-recorded portion, and extent of peeling of the printed portion were visually observe, and abrasion resistance evaluation was conducted according to the following evaluation criteria.

### Evaluation Criteria

A: There is no staining on the cannequin, there is no staining in the non-recorded portion, and the printed portion was not peeled.
B: There is little staining on the cannequin, there is little staining in the non-recorded portion, and the printed portion was almost not peeled.
C: There is staining on the cannequin and there is staining in the non-recorded portion but the extent of staining is small, and the printed portion was almost not peeled.
D: There is staining on the cannequin, there is staining in the non-recorded portion, and the printed portion was partially peeled.

### 4. Evaluation Results

From the evaluation results in FIG. 2, it has been found that Examples 1 to 8 are all excellent in sedimentation performance and discharge stability as well as excellent in wear resistance and marker resistance compared with Comparative Examples 1 and 2 in which no biomass resin was used and Comparative Examples 3 and 4 in which no lignin compound was used.

What is claimed is:

1. An ink jet ink composition comprising:
a pigment;
a dispersant; and
a biomass resin, the ink jet ink composition being an aqueous ink, wherein
the pigment is dispersed by the dispersant in water, and the dispersant includes a lignin compound.

2. The ink jet ink composition according to claim 1, wherein
the pigment includes any one or more kinds of vegetable charcoal and vegetable oil charcoal.

3. The ink jet ink composition according to claim 1, wherein
the lignin compound includes a lignin sulfonate.

4. The ink jet ink composition according to claim 1, wherein
the biomass resin has any one or more kinds of an alicyclic structure and an aromatic ring structure.

5. The ink jet ink composition according to claim 1, wherein
a mass ratio (B/A) of a content B of the biomass resin to a content A of the pigment is 0.5 to 6.0.

6. The ink jet ink composition according to claim 1, wherein
a mass ratio (C/A) of a content C of the lignin compound to a content A of the pigment is 0.5 to 2.0.

7. The ink jet ink composition according to claim 1, wherein
a volume average particle diameter D50 is 300 nm or less.

8. The ink jet ink composition according to claim 1, wherein
a biomass degree of an ink solid content is 60% to 100%.

9. The ink jet ink composition according to claim 1, further comprising a polyol as an organic solvent.

10. A recording method, comprising:
an ink adhering step of discharging, from an ink jet head, the ink jet ink composition according to claim 1 and adhering same to a recording medium.
